(19) United States
(12) Patent Application Publication
(10) Pub. No.: US 2014/0152947 A1
(43) Pub. Date: Jun. 5, 2014

(54) MANUFACTURING DEVICE FOR LIQUID CRYSTAL PANEL AND LIQUID CRYSTAL PANEL

(71) Applicants: Guodong Zhao, Shenzhen (CN); Tao Song, Shenzhen (CN); FangFu Chen, Shenzhen (CN); Tao Ding, Shenzhen (CN)

(72) Inventors: Guodong Zhao, Shenzhen (CN); Tao Song, Shenzhen (CN); FangFu Chen, Shenzhen (CN); Tao Ding, Shenzhen (CN)

(73) Assignee: SHENZHEN CHIAN STAR OPTOELECTRONICS TECHNOLOGY CO., LTD., Shenzhen, Guangdong (CN)

(21) Appl. No.: 13/813,940

(22) PCT Filed: Dec. 24, 2012
(86) PCT No.: PCT/CN2012/087256

§ 371 Date: Feb. 1, 2013

(30) Foreign Application Priority Data
Dec. 5, 2012 (CN) 201220664048.9

(51) Int. Cl. G02F 1/1335; G06F 17/50

(52) U.S. Cl. CPC G02F 1/133512; G06F 17/5072
USPC 349/110; 716/55

(57) ABSTRACT

The manufacturing device for a liquid crystal panel which has a non-displaying area includes a two-dimensional code generating module configured for generating a rectangle-shaped two-dimensional code according to an amount of the data needed to be represented and a two-dimensional forming module configured for forming a photomask according to a figure of the rectangle-shaped two-dimensional code and forming the rectangle-shaped two-dimensional code on the non-displaying area of the liquid crystal panel. With the manufacturing device of the present disclosure, the rectangle-shaped two-dimensional code can be formed on the non-displaying area of the present disclosure. The width of the rectangle-shaped two-dimensional code is less than that of the present square-shaped two-dimensional code used for representing the same data, thus, the width of the non-displaying area can be reduced without reducing the area of the two-dimensional code to allow the liquid crystal display to have a narrow frame.

### BACKGROUND

1. Technical Field

The present disclosure relates to technologies of liquid crystal panels, and particularly, to a manufacturing device for a liquid crystal panel and a liquid crystal panel.

2. Description of Related Art

The two-dimensional code uses a geometric graph that alternates black and white regularly on a plane (in two dimensions) to record data information. The information of the two-dimensional code draws upon the concept of 0s and 1s that constitute the internal logics of a computer, and uses several geometric forms corresponding to the binary system to represent text and value information. The information is identified by an image input device or a photoelectric scanner automatically, and processed automatically. At present, the common two-dimensional codes include a stacked two-dimensional code and a matrix two-dimensional code. The matrix two-dimensional code is commonly used in the field of liquid crystal panel to identify the liquid crystal panel and to monitor the manufacturing process of the liquid crystal panel. In the field of liquid crystal panel, the matrix two-dimensional code is square-shaped and is formed on a non-displaying area of an array substrate.

On the other hand, with the improvement of manufacturing technique of the products having liquid crystal panels, products having narrow frames have become a trend in the liquid crystal displaying industry. The space preserved on the liquid crystal panel of a narrow-frame display device in which the two-dimensional code is formed becomes smaller and smaller. Especially, the width of the non-displaying area of the liquid crystal panel becomes smaller and smaller. However, limited to the smallest size of the liquid crystal panel and the recognition accuracy of the two-dimension code reader, the area of the two-dimensional code on the liquid crystal panel cannot be unrestrictedly small. However, to the square-shaped two-dimensional code, the width of the non-displaying area taken by the two-dimensional code is determined by the area of the two-dimensional code. Therefore, the non-displaying area is required to wide enough for forming the two-dimensional code, and the width of the frame of the product with the liquid crystal panel cannot be reduced to meet requirements about narrow-frame design.

### SUMMARY

The present disclosure provides a manufacturing device for a liquid crystal panel, which allows the liquid crystal panel to have a narrow frame while forming a two-dimensional code on the liquid crystal panel.

The manufacturing device for a liquid crystal panel which has a non-displaying area includes:

a two-dimensional code generating module configured for generating a rectangle-shaped two-dimensional code according to an amount of data needed to be represented; and

a two-dimensional forming module configured for forming a photomask according to a figure of the rectangle-shaped two-dimensional code and forming the rectangle-shaped two-dimensional code on the non-displaying area of the liquid crystal panel.

Preferably, the two-dimensional code generating module includes an obtaining unit, a choosing unit, and a generating unit; the obtaining unit is configured for obtaining the data needed to be represented, the choosing unit is configured for choosing a corresponding specification of the rectangle-shaped two-dimensional code according to the amount of the data, and the generating unit is configured for encoding the data obtained by the obtaining unit, building a two-dimensional code matrix according to the chosen specification, and generating the rectangle-shaped two-dimensional code.

Preferably, the two-dimensional code forming module includes a defining unit and a forming unit; the defining unit is configured for defining a two-dimensional code displaying area corresponding to a size of the rectangle-shaped two-dimensional code on the non-displaying area, the forming unit is configured for forming the photomask according to the figure of the rectangle-shaped two-dimensional code, exposing the liquid crystal panel using the photomask, and forming the rectangle-shaped two-dimensional code on the two-dimensional code displaying area by performing an exposing process and an etching process.

Preferably, the two-dimensional code displaying area is spaced apart from a corresponding edge of the non-displaying area for a predetermined distance.

Preferably, the rectangle-shaped two-dimensional code includes a number of black modules and a number of white modules, and a length of each black module or white module ranges from 30 um to 70 um.

Preferably, the rectangle-shaped two-dimensional code includes a number of black modules and a number of white modules, and the predetermined distance is equal to or twice as long as the length of each black module or white module.

Preferably, edges of the two-dimensional code displaying area are respectively parallel to the edges of the non-displaying area.

The present disclosure further provides a liquid crystal panel, including:

a non-displaying area; and

a rectangle-shaped two-dimensional code formed on the non-displaying area.

Preferably, a two-dimensional code displaying area corresponding to a size of the rectangle-shaped two-dimensional code is formed on the non-displaying area, edges of the two-dimensional code displaying area are respectively parallel to edges of the non-displaying area, and the two-dimensional code displaying area is spaced apart from the corresponding edge of the non-displaying area for a predetermined distance.

Preferably, the rectangle-shaped two-dimensional code includes a number of black modules and a number of white modules, and the predetermined distance is equal to or twice as long as a length of each black module or white module.

The present disclosure further yet provides another manufacturing device for a liquid crystal panel which has a non-displaying area, including:

a two-dimensional code generating module configured for generating a rectangle-shaped two-dimensional code according to an amount of data needed to be represented;

a two-dimensional code forming module configured for defining a two-dimensional code displaying area on the non-displaying area of the liquid crystal panel according to a figure of the rectangle-shaped two-dimensional code, forming a photomask according to the figure of the rectangle-shaped two-dimensional code, and forming the rectangle-shaped two-dimensional code on the two-dimensional code displaying area using the photomask the two-dimensional code displaying area corresponding to rectangle-shaped two-dimensional code; and

the two-dimensional code displaying area corresponding to a size of the rectangle-shaped two-dimensional code, and each edge of two-dimensional code displaying area being parallel to the corresponding edge of the non-displaying area and spaced from the corresponding edge of the non-displaying area for a predetermined distance.

Preferably, the two-dimensional code generating module includes an obtaining unit, a choosing unit, and a generating unit; the obtaining unit is configured for obtaining the data needed to be represented, the choosing unit is configured for choosing a corresponding specification of the rectangle-shaped two-dimensional code according to the amount of the data, and the generating unit is configured for encoding the data obtained by the obtaining unit, building a two-dimensional code matrix according to the chosen specification, and generating the rectangle-shaped two-dimensional code.

Preferably, the two-dimensional code forming module includes a defining unit and a forming unit; the defining unit is configured for defining the two-dimensional code displaying area on the non-displaying area, the forming unit is configured for forming the photomask, exposing the liquid crystal panel using the photomask, and forming the rectangle-shaped two-dimensional code on the two-dimensional code displaying area by performing an exposing process and an etching process.

Preferably, the rectangle-shaped two-dimensional code includes a number of black modules and a number of white modules, a length of each black module or white module ranges from 30 um to 70 um.

Preferably, the rectangle-shaped two-dimensional code includes a number of black modules and a number of white modules, and the predetermined distance is equal to or twice as long as the length of each black module or white module.

The two-dimensional code generating module of the manufacturing device of the present disclosure can choose the corresponding specification of the rectangle-shaped two-dimensional code according to the amount of the data which can identify the liquid crystal panel and monitor the manufacturing process of the liquid crystal panel, and encode the data to generate the corresponding rectangle-shaped two-dimensional code. The two-dimensional code forming module can perform the exposing process, developing process, and etching process to form the rectangle-shaped two-dimensional code on the non-displaying area of the liquid crystal panel. Since the two-dimensional code formed on the non-displaying area is rectangle-shaped, thus, based on the situation that the amount of data represented remains unchanged, the width of the rectangle-shaped two-dimensional code of the present disclosure is less than that of the square-shaped two-dimensional code, which reduces the width of the non-displaying area, allows the liquid crystal panel to have a narrow frame to meet corresponding requirements.

### DESCRIPTION OF THE DRAWINGS

Many aspects of the embodiments can be better understood with reference to the following drawings. The components in the drawings are not necessarily dawns to scale, the emphasis instead being placed upon clearly illustrating the principles of the embodiments. Moreover, in the drawings, like reference numerals designate corresponding parts throughout the several views.

FIG. 1 is a functional block diagram of a manufacturing device for a liquid crystal panel in accordance with an embodiment of the present disclosure;

FIG. 2 is a functional block diagram of a two-dimensional code generating module of the manufacturing device of FIG. 1;

FIG. 3 is a functional block diagram of a two-dimensional code forming module of the manufacturing device of FIG. 1; and

FIG. 4 is a schematic view of a liquid crystal panel having a rectangle-shaped formed by the manufacturing device of FIG. 1.

### DETAILED DESCRIPTION

The disclosure is illustrated by way of example and not by way of limitation in the figures of the accompanying drawings in which like references indicate similar elements. It should be noted that references to “an” or “one” embodiment is this disclosure are not necessarily to the same embodiment, and such references mean at least one.

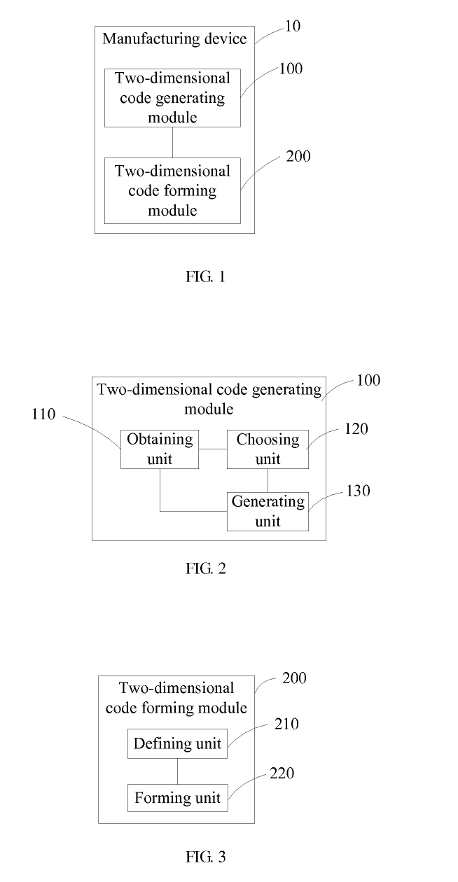

Referring to FIG. 1, which is a functional block diagram of a manufacturing device 10 for a liquid crystal panel in accordance with an embodiment of the present disclosure. The manufacturing device 10 is used for forming a two-dimensional code on the liquid crystal panel such that the a two-dimensional code reader can read the two-dimensional code on the liquid crystal panel to indentify the liquid crystal panel and monitor the manufacturing process of the liquid crystal panel. In the embodiment, the manufacturing device 10 is used for forming a rectangle-shaped two-dimensional code on a non-displaying area of the liquid crystal panel, wherein “rectangle” has a pair of long sides and a pair of short sides. In a case that the amount of the data represented by the rectangle-shaped two-dimensional code and the amount of the data represented by the present square-shaped two-dimensional code are equal to each other, a width of the rectangle-shaped two-dimensional code is less than that of the present square-shaped two-dimensional code, which allows a width of the non-displaying area to be reduced to provide a narrow frame for the liquid crystal display. The manufacturing device 10 includes a two-dimensional code generating module 100 and a two-dimensional code forming module 200 being capable of cooperating with the two-dimensional code generating module 100 to form the two-dimensional code on the liquid crystal panel.

The two-dimensional code generating module 100 is used for generating the rectangle-shaped two-dimensional code according to the amount of the to-be-represented data. As shown in FIG. 2, in the embodiment, the two-dimensional code generating module 100 includes an obtaining unit 110, a choosing unit 120, and a generating unit 130. The obtaining unit 110 is used for obtaining the data needed to be represented. In the field of liquid crystal panels, the to-be-represented data obtained by the obtaining unit 110 is generally an Arabian numerical string consisting of several numbers. The Arabian numerical string is used for representing the ID of the liquid crystal panel or the manufacturing process of the liquid crystal panel, and can be encoded to a two-dimensional code and shown on the liquid crystal panel. The Arabian numerical string can be input into the obtaining unit 110 via an input device such as a keyboard. The choosing unit 120 is connected to the obtaining unit 110 for choosing a corresponding specification of the rectangle-shaped two-dimensional code according to the amount of the to-be-represented data obtained by the obtaining unit 110. The specification of the rectangle-shaped two-dimensional code is determined by the number of the columns and rows of the black modules and white modules which are respectively used for representing the bit streams of 0s and 1s. In the field of liquid crystal panels, since the Arabian numerical string consisting of ten to twelve numbers, thus, there are two types of suitable specifications of the rectangle-shaped two-dimensional code: 8*32 and 12*26.

The generating unit 130 is used for encoding the to-be-represented data obtained by the obtaining unit 110, building a two-dimensional code matrix according to the specification of the rectangle-shaped two-dimensional code chosen by the choosing unit 120, and further generating the rectangle-shaped two-dimensional code. After receiving the Arabian numerical string obtained by the obtaining unit 110, the generating unit 130 encodes the Arabian numerical string using a predetermined mode, such as the binary mode to form a corresponding code sequence. The generating unit 130 creates data information according to the code sequence, fills the data information into the area of the two-dimensional code corresponding to the chosen specification, and finally forms the rectangle-shaped two-dimensional code carrying the to-be-represented data information needed to be represented.

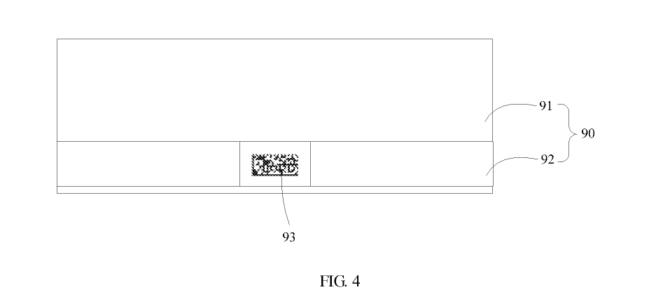

The two-dimensional code forming module 200 is used for forming a photomask according to a figure of the rectangle-shaped two-dimensional code and forming the rectangle-shaped two-dimensional code on the non-displaying area of the liquid crystal panel. As shown in FIG. 3, in the embodiment, the two-dimensional code forming module 200 includes a defining unit 210 and a forming unit 220. The defining unit 210 is used for defining a two-dimensional code displaying area on the non-displaying area corresponding to the size of the rectangle-shaped two-dimensional code. In order to make sure that the rectangle-shaped two-dimensional code can be recognized easily, edges of the two-dimensional code displaying area are respectively spaced apart from the edges of the non-displaying area or other components of the liquid crystal panel for a predetermined distance. In the embodiment, the predetermined distance between the two-dimensional code displaying area and the corresponding edge of the non-displaying or the corresponding component of the liquid crystal panel is equal to or twice as long as a length of each black/white module. For example, if the length of each black module ranges from 30 um to 70 um, the distance between the two-dimensional code displaying area and the corresponding edge of the non-displaying area or the corresponding component of the liquid crystal panel ranges from 30 um to 70 um or ranges from 60 um to 140 um. In this way, a boundary of the rectangle-shaped two-dimensional code can be recognized to reduce the error of the two-dimensional code reader when the reader reads the rectangle-shaped two-dimensional code. Additionally, in order to reduce the width of the rectangle-shaped two-dimensional code, the two long sides of the two-dimensional code displaying area are respectively parallel to the two long sides of the non-displaying area, and the two short sides of the two-dimensional code displaying area are respectively parallel to the two short sides of the non-displaying area.

The forming unit 220 is used for forming the photomask according to the figure of the rectangle-shaped two-dimensional code, exposing the liquid crystal panel using the photomask, and forming the rectangle-shaped two-dimensional code on the two-dimensional code displaying area by performing a developing process and an etching process. It is noted that, during the process of forming the photomask, the size of each black module or white module in the figure of the rectangle-shaped two-dimensional code can be determined according to the accuracy of a two-dimensional code manufacturing machine and the accuracy of the two-dimensional code reader. In the embodiment, the length of each black module or white module in the figure of the rectangle-shaped two-dimensional code formed on the photomask ranges from 30 um to 70 um. During the exposing process, a metal layer and a photoresist layer are coated on the surface of a glass substrate in this order, and the photomask corresponds to the glass substrate to allow the figure of the rectangle-shaped two-dimensional code to be aligned with the rectangle-shaped two-dimensional code displaying area. After that, the forming unit 220 exposes the glass substrate using the photomask and further develops and etches the glass substrate, which finally forms the figure of the rectangle-shaped two-dimensional code on the two-dimensional code displaying area.

Referring to FIG. 4, which is a schematic view of the liquid crystal panel having a rectangle-shaped manufactured by the manufacturing device. The liquid crystal panel 90 includes a displaying area 91 and the non-displaying area 92. A rectangle-shaped two-dimensional code 93 is formed on the non-displaying area 92. As shown in FIG. 4, based on the situation that the amount of data needed to be represented remains unchanged, the width of the rectangle-shaped two-dimensional code is less than that of the square-shaped two-dimensional code. Thus, compared to the width of the non-displaying area of the present liquid crystal panel, the width of the non-displaying area of the liquid crystal panel of the present disclosure is reduced without reducing the amount of data represented by the two-dimensional code, which allows the liquid crystal panel to have a narrow frame, reduces the area of the non-displaying area of the liquid crystal panel, and further improves the utilization rate of the liquid crystal panel.

The two-dimensional code generating module 100 of the manufacturing device 10 of the present disclosure can choose the corresponding specification of the rectangle-shaped two-dimensional code according to the amount of the data which can identify the liquid crystal panel and monitor the manufacturing process of the liquid crystal panel, and encode the data to generate the corresponding rectangle-shaped two-dimensional code. The two-dimensional code forming module 200 can perform the exposing process, developing process, and etching process to form the rectangle-shaped two-dimensional code on the non-displaying area of the liquid crystal panel. Since the two-dimensional code formed on the non-displaying area is rectangle-shaped, thus, based on the situation that the amount of data represented remains unchanged, the width of the rectangle-shaped two-dimensional code of the present disclosure is less than that of the square-shaped two-dimensional code, which reduces the width of the non-displaying area, allows the liquid crystal panel to have a narrow frame to meet corresponding requirements.

Even though information and the advantages of the present embodiments have been set forth in the foregoing description, together with details of the mechanisms and functions of the present embodiments, the disclosure is illustrative only; and that changes may be made in detail, especially in matters of shape, size, and arrangement of parts within the principles of the present embodiments to the full extend indicated by the broad general meaning of the terms in which the appended claims are expressed.

What is claimed is:

1. A manufacturing device for a liquid crystal panel which has a non-displaying area, comprising:
a two-dimensional code generating module configured for generating a rectangle-shaped two-dimensional code according to an amount of data needed to be represented; and
a two-dimensional forming module configured for forming a photomask according to a figure of the rectangle-shaped two-dimensional code and forming the rectangle-shaped two-dimensional code on the non-displaying area of the liquid crystal panel.

2. The manufacturing device as claimed in claim 1, wherein the two-dimensional code generating module comprises an obtaining unit, a choosing unit, and a generating unit; the obtaining unit is configured for obtaining the data needed to be represented, the choosing unit is configured for choosing a corresponding specification of the rectangle-shaped two-dimensional code according to the amount of the data, and the generating unit is configured for encoding the data obtained by the obtaining unit, building a two-dimensional code matrix according to the chosen specification, and generating the rectangle-shaped two-dimensional code.

3. The manufacturing device as claimed in claim 1, wherein the two-dimensional code forming module comprises a defining unit and a forming unit; the defining unit is configured for defining a two-dimensional code displaying area corresponding to a size of the rectangle-shaped two-dimensional code on the non-displaying area, the forming unit is configured for forming the photomask according to the figure of the rectangle-shaped two-dimensional code, exposing the liquid crystal panel using the photomask, and forming the rectangle-shaped two-dimensional code on the two-dimensional code displaying area by performing an exposing process and an etching process.

4. The manufacturing device as claimed in claim 3, wherein the two-dimensional code displaying area is spaced apart from a corresponding edge of the non-displaying area for a predetermined distance.

5. The manufacturing device as claimed in claim 4, wherein the rectangle-shaped two-dimensional code comprises a number of black modules and a number of white modules, and a length of each black module or white module ranges from 30 um to 70 um.

6. The manufacturing device as claimed in claim 4, wherein the rectangle-shaped two-dimensional code comprises a number of black modules and a number of white modules, and the predetermined distance is equal to or twice as long as the length of each black module or white module.

7. The manufacturing device as claimed in claim 3, wherein edges of the two-dimensional code displaying area are respectively parallel to the edges of the non-displaying area.

8. A liquid crystal panel, comprising:
a non-displaying area; and
a rectangle-shaped two-dimensional code formed on the non-displaying area.

9. The liquid crystal panel as claimed in claim 8, wherein a two-dimensional code displaying area corresponding to a size of the rectangle-shaped two-dimensional code is formed on the non-displaying area, edges of the two-dimensional code displaying area are respectively parallel to edges of the non-displaying area, and the two-dimensional code displaying area is spaced apart from the corresponding edge of the non-displaying area for a predetermined distance.

10. The liquid crystal panel as claimed in claim 9, wherein the rectangle-shaped two-dimensional code comprises a number of black modules and a number of white modules, and the predetermined distance is equal to or twice as long as a length of each black module or white module.

11. A manufacturing device for a liquid crystal panel which has a non-displaying area, comprising:
a two-dimensional code generating module configured for generating a rectangle-shaped two-dimensional code according to an amount of data needed to be represented; and
a two-dimensional code forming module configured for defining a two-dimensional code displaying area on the non-displaying area of the liquid crystal panel according to a figure of the rectangle-shaped two-dimensional code, forming a photomask according to the figure of the rectangle-shaped two-dimensional code, and forming the rectangle-shaped two-dimensional code on the two-dimensional code displaying area using the photomask the two-dimensional code displaying area corresponding to rectangle-shaped two-dimensional code; and
the two-dimensional code displaying area corresponding to a size of the rectangle-shaped two-dimensional code, and each edge of two-dimensional code displaying area being parallel to the corresponding edge of the non-displaying area and spaced from the corresponding edge of the non-displaying area for a predetermined distance.

12. The manufacturing device as claimed in claim 11, wherein the two-dimensional code generating module comprises an obtaining unit, a choosing unit, and a generating unit; the obtaining unit is configured for obtaining the data needed to be represented, the choosing unit is configured for choosing a corresponding specification of the rectangle-shaped two-dimensional code according to the amount of the data, and the generating unit is configured for encoding the data obtained by the obtaining unit, building a two-dimensional code matrix according to the chosen specification, and generating the rectangle-shaped two-dimensional code.

13. The manufacturing device as claimed in claim 11, wherein the two-dimensional code forming module comprises a defining unit and a forming unit; the defining unit is configured for defining the two-dimensional code displaying area on the non-displaying area, the forming unit is configured for forming the photomask, exposing the liquid crystal panel using the photomask, and forming the rectangle-shaped two-dimensional code on the two-dimensional code displaying area by performing an exposing process and an etching process.

14. The manufacturing device as claimed in claim 11, wherein the rectangle-shaped two-dimensional code comprises a number of black modules and a number of white modules, a length of each black module or white module ranges from 30 um to 70 um.

15. The manufacturing device as claimed in claim 11, wherein the rectangle-shaped two-dimensional code comprises a number of black modules and a number of white modules, and the predetermined distance is equal to or twice as long as the length of each black module or white module.
